(19) United States
(12) Patent Application Publication
(10) Pub. No.: US 2011/0085330 A1
(43) Pub. Date: Apr. 14, 2011

(54) LED LIGHTING UNIT HAVING A STRUCTURED SCATTERING SHEET

(75) Inventors: Heinz Pudleiner, Krefeld (DE); Günther Walze, Taipei (TW); Andreas Lyding, Duisburg (DE)

(73) Assignee: Bayer MaterialScience AG, Leverkusen (DE)

(21) Appl. No.: 12/901,759

(22) Filed: Oct. 11, 2010

(30) Foreign Application Priority Data
Oct. 9, 2009 (EP) 09012789.5

(51) Int. Cl. F21V 7/00

(52) U.S. Cl. 362/235

(57) ABSTRACT

The present invention relates to an LED lighting unit containing a scattering sheet consisting of at least one transparent plastic, which has light-guiding elements at least on the front side.

### BACKGROUND OF THE INVENTION

1. Field of the Invention

The field of the present invention relates to LED lighting units, and particularly LED lighting units containing a scattering sheet consisting of at least one transparent plastic and having light-guiding elements at least on the front side.

2. Background

In principle, a light-emitting diode (LED) lighting unit with direct backlighting has the structure described below. It generally comprises a housing in which, depending on the size and application field of the lighting unit, a different number of LEDs are accommodated. The housing may be a box having flat front and rear sides, and arbitrarily shaped side surfaces; more complex constructs may have side surfaces which have different shapes on the inside and outside. The LEDs are usually placed internally on the rear side of the box and arranged in a regular grid. This grid can be described by the number of rows in the longitudinal (n) and transverse (m) directions. The numbers of rows represented by the variables “n” and “m” are respectively numbers greater than or equal to 1. The housing inner rear side between the LEDs is equipped with a preferably white diffusely light-reflecting surface. On this lighting system, there is usually a diffuser sheet or plate which may have a thickness of from 1 to 3 mm, preferably a thickness of from 1.5 to 2.5 mm. This diffuser sheet is intended to scatter the light uniformly so that the point pattern of the LED matrix disappears and a maximally homogeneous appearance can be achieved. The distance from the sheet to the LED matrix, and therefore the housing depth, is generally selected so as to ensure maximally homogeneous illumination. The frame of the light unit, which encloses the matrix comprising the LEDs, is configured either as a simple box or has a light-guiding free-form shape. It may be configured on the inside so as to be diffusely white-reflective or metallically reflective.

Light-scattering translucent products consisting of polycarbonate with various light-scattering additives, and shaped parts produced therefrom, are already known from the prior art.

For example, EP-A 634 445 discloses light-scattering compositions which contain polymer particles based on vinyl acrylate with a core/shell morphology in combination with TiO2.

The use of light-scattering polycarbonate sheets in flat screens is described in US-A 2004/0066645. Here, polyacrylates, PMMA, polytetrafluoroethylenes, polyalkyltrialkoxysiloxanes and mixtures of these components are mentioned as light-scattering pigments.

DE-A 10 2005 039 413 describes PC diffuser plates which contain from 0.01% to 20% of scattering pigment.

With such diffuser sheets or plates, however, it is not possible to achieve a sufficient homogeneity of the light distribution in LED lighting units, and the individual LEDs continue to be visible as discrete light sources.

Homogenisation of the light distribution by means of surface structures is described, for example, in JP-A 2006/284697 or US 2006/10262666. These are based on simple barrel-like or prismatic webs or a combination thereof as surface structuring, which under certain circumstances contain slight variations such as notches. Mathematically, these structures can often be described by ellipse sections and are in this case generally referred to as lenticular structures. The achievable homogeneity is limited, and still even less than the homogeneity achievable with conventional diffuser plates.

CN-A 1924620 describes light-guiding structures in plastic with a scattering additive, which consist of truncated prism structures. These structures are intended to produce three clear images of the lamps which are broadened by the additionally used scattering additive, also inside the structure, so as to achieve homogeneous backlighting. In this configuration, however, the scattering additive being used interferes with the light-guiding effect of the structure, so that in the end homogeneous backlighting cannot be achieved.

US-A 2007047260, US-A 2006250819 and DE-A 10 2007 033300 describe compound parabolic concentrators on scattering plates for backlight units, i.e. indirect backlighting. For BLUs, however, inter alia an increase in brightness is of prime importance and light scattered at an upstream diffuser plate or diffuser layer is subsequently collected (collimated) again by such CPC structures on a scattering plate or scattering layer lying in front, in order to improve the brightness.

### SUMMARY OF THE INVENTION

The present invention is directed toward an LED lighting unit having a structure which is as simple as possible and which has improved homogenisation of the light distribution. The aim is to achieve maximally homogeneous illumination in which the individual light sources can no longer be perceived as discrete light sources by the human eye.

The lighting unit includes:
at least one light-reflecting surface
one or more light-emitting diode(s) (LED(s))
at least one scattering sheet made of at least one transparent plastic,
the LED(s) being arranged in front of at least one reflective surface and behind at least one scattering sheet, characterised in that at least the front side of the scattering sheet comprises light-guiding structures consisting of a lens region and a convex CPC region (compound parabolic concentrator region).

The lighting unit leads to much greater homogenisation than conventional diffuser plates or sheets, which are otherwise used for such lighting units.

Accordingly, an improved lighting unit is disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1: cross section through a light-guiding structure;

FIG. 2: three-dimensional illustration of a light-guiding structure;

FIG. 3: design principle of a compound parabolic concentrator;

FIG. 4a: schematic structure of a lighting unit according to a comparative example;

FIG. 4b: brightness variation of the lighting unit according to the comparative example, measured using a CCD camera;

FIG. 4c: brightness variation of the lighting unit according to the comparative example;

FIG. 5a: schematic structure of a lighting unit according to Example 2;

FIG. 5b: brightness variation of the lighting unit according to Example 2, measured using a CCD camera;

FIG. 5c: brightness variation of the lighting unit according to Example 2;

FIG. 6a: schematic structure of a lighting unit according Example 3;

FIG. 6b: brightness variation of the lighting unit according to Example 3, measured using a CCD camera; and

FIG. 6c: brightness variation of the lighting unit according to Example 3.

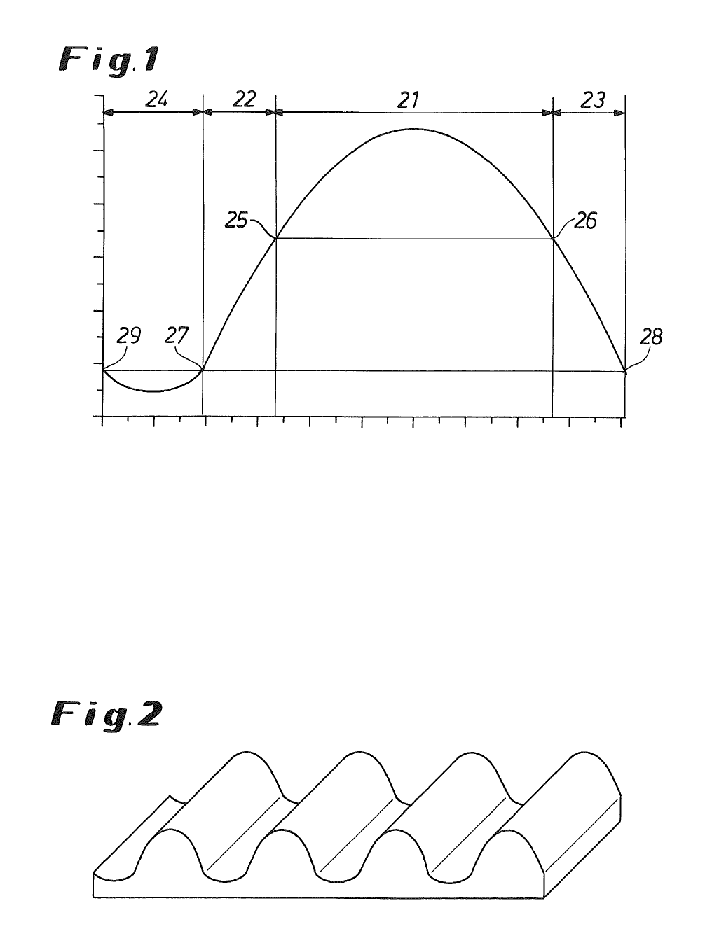

In the figures, the references represent components as follows:

1 light-reflecting surface

2 LEDs

3 diffuser plate

4 scattering sheet with light-guiding structure

5 diffuser sheet

6 luminous density

7 distance

21 polynomial region of the light-guiding structure

22 left CPC region (parabola P1) of the light-guiding structure

23 right CPC region (parabola P2) of the light-guiding structure

24 lens region of the light-guiding structure

25 upper endpoint F1 of the CPC

26 upper endpoint F2 of the CPC

27 lower endpoint E3 of the CPC

28 lower endpoint E4 of the CPC

29 left endpoint L1 of the lens region

31 aperture angle θ₁ of the parabola P1

32 aperture angle θ₂ of the parabola P2

33 CPC body

34 X coordinate

35 Y coordinate

36 shortening of the CPC body, determined by the truncation factor

45 lower endpoint E1 of the unshortened CPC

46 lower endpoint E2 of the unshortened CPC

### DETAILED DESCRIPTION OF THE PREFERRED EMBODIMENTS

As used herein, the expressions “front side” and “rear side” describe the two large opposing surfaces of the scattering sheet. The front side lies away from the light source, and the rear side lies towards the light source.

As used herein, the expression “convex CPC region” means that the wider part of the CPC faces in the direction of the rear side.

As used herein, the expression “translation-invariant” means that the structure exhibits no variations, or at least no significant or subsequent variations, over the surface in one direction, whereas in a direction perpendicular thereto it has a shape with elongate elevations and depressions, i.e. it represents a groove structure.

As used herein, the expression “overmodulated” means that along the translation-invariant direction, i.e. along the groove structure, the structure has an additional variation which is independent of the variation transversely to the groove structure. Considered mathematically, the effective surface structure constitutes an addition of the groove structure with a structure, referred to the below as overmodulated, independent thereof. This overmodulated structure may be a sinusoidal function, a random scattering structure or any other desired function.

As used herein, the expression “lens region” means that a part of the light-guiding structure can be described mathematically by a lens-like function.

As used herein, the expression “CPC region” means that a part of the light-guiding structure can be described mathematically by a CPC structure function.

As used herein, the expression “identical” means that all the lens regions have an identical shape and all the CPC regions have an identical shape, i.e. can be described by the same parameters.

As used herein, the expression “dependent” means that neighbouring lens regions or CPC regions respectively have a shape which, although it may be different, is nevertheless dictated by the neighbouring region i.e. it is dependent on it. This expression is used to describe structures which overall have different shapes but nevertheless are periodically variable.

As used herein, the expression “independent” means that neighbouring lens regions or CPC regions have a shape whose describing parameters are entirely independent of one another. Each of the individual structures may in this case have a different shape.

The light-guiding structures are also referred to below as ACPCs (advanced compound parabolic concentrators)

The light-guiding structures are preferably translation-invariant.

The lens regions and CPC regions may respectively be identical, dependent or independent. In one embodiment, all the lens regions are identical and all the CPC regions are identical.

The individual lens regions and CPC regions may furthermore be described by independent parameter sets.

The CPC region may be determined, and is preferably determined by:

a) calculating the aperture angles θ₁ and θ₂ in the medium from the Fresnel equations by means of the defined acceptance angles;

b) constructing the parabola branch P₁ with the aperture angle θ₁ in the medium and the parabola branch P₂ with the aperture angle θ₂ in the medium according to the equation:

$${y}_{1 , 2} = \frac{{( x ∓ cos {θ}_{1 , 2} )}^{2}}{2 ( 1 ∓ sin {θ}_{1 , 2} )} - \frac{1 \pm sin {θ}_{1 , 2}}{2}$$

where θ_{1,2} is the aperture angle in the medium of the left (θ₁) and right (θ₂) parabola, x is the X coordinate, and y_{1,2} is the Y coordinate of the left (y₁) and right (y₂) parabola;

c) calculating the endpoints F₁, F₂ and E₁, E₂ of the parabola branches;

d) rotating the parabola branch P₁ through the aperture angle −θ₁ in the medium and the parabola branch P₂ through the aperture angle θ₂ in the medium, and translating the parabola branch P₂ along the x axis;

e) optionally, in the case of an asymmetric variant with θ₁≠θ₂, determining the slope of the inclination surface determined by the points E₁ and E₂;

f) determining the effective acceptance angles in air from the geometry constructed in steps a) to e);

g) comparing the effective acceptance angles with the defined acceptance angles and, if there is a difference of more than 0.001%, repeating steps a) to f) with corrected acceptance angles instead of the defined acceptance angles in step a), the corrected acceptance angles not being equal to the defined acceptance angles, and the corrected acceptance angles being selected so that the effective acceptance angles from step f) coincide with the defined acceptance angles; and

h) when a difference of 0.001% or less is reached between the effective acceptance angles and the defined acceptance angles, shortening the parabolas in the y direction by the extent determined by the shortening factor.

In one embodiment, the defined acceptance angle θ₁ lies between 5° and 60° and the defined acceptance angle θ₂ lies between 5° and 60°.

In another embodiment, the shortening in step h) is simple truncation.

In another embodiment, the shortening in step h) is compression of the geometry along the y axis by the factor determined by the shortening factor.

In another preferred embodiment, θ₁=θ₂.

In another embodiment, the cross section of the lens is an ellipse.

In another embodiment, the overall period lies in a range of between 10 μm and 1 mm, preferably 30 μm-500 μm, particularly preferably 50 μm-300 μm.

In another embodiment, the CPC region has a continuous polynomial closure. This means that the structure between the two points F1 and F2 of a CPC region can be described by a continuous polynomial function. In one embodiment, the polynomial function is an n^{th} order polynomial, n being less than or equal to 32. In another embodiment, the polynomial function is a fourth order polynomial which is continuously differentiable between the points F₁ and F₂.

In another embodiment, the structure between the two points F1 and F2 of a CPC region can be described by a parabola, hyperbola, circle function, sinusoidal function or straight line.

In another embodiment, the regions deviate by less than 5% or at least less than 10% from one of the geometries described above.

In another embodiment, the structures cover at least 80%, at least 90%, at least 95% or 100% of the surface of the front side.

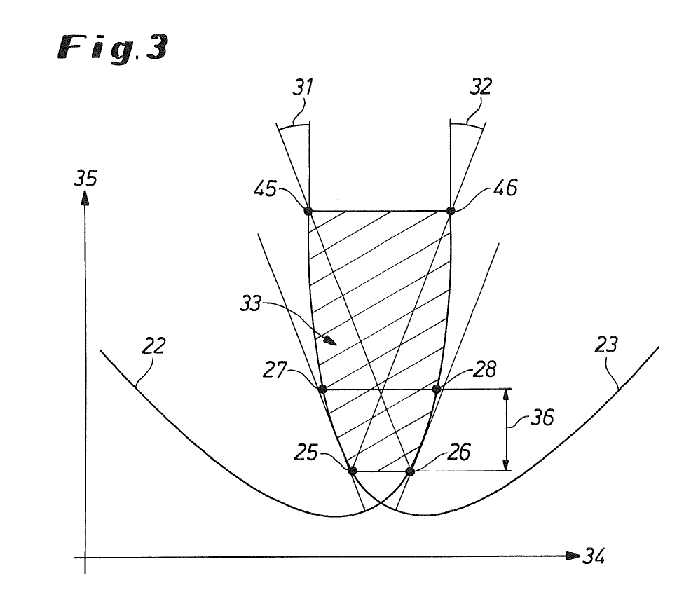

The CPC region follows the design of a conventional dielectric CPC (compound parabolic concentrator) with the difference of a continuous polynomial closure (polynomial). Dielectric CPCs are conventionally used as concentrator systems and—in contrast to metallic CPCs which have been known for even longer—are based on the optical principle of total internal reflection. In order to mathematically determine the CPC in the form used here, the determining parameters are the two—here usually identical—acceptance angles and the shortening factor. CPCs (FIG. 3) are designed according to the following procedure using the formulae stated. The procedure described involves an implicit optimisation problem:
1. Calculation of the aperture angles θ₁ and θ₂ (31 and 32) in the medium from the Fresnel equations by means of the defined acceptance angles.
2. Construction of the parabola branch P₁ (22) with the aperture angle θ₁ (31) in the medium and the parabola branch P₂ (23) with the aperture angle θ₂ (32) in the medium according to the equation:

$${y}_{1 , 2} = \frac{{( x ∓ cos {θ}_{1 , 2} )}^{2}}{2 ( 1 ∓ sin {θ}_{1 , 2} )} - \frac{1 \pm sin {θ}_{1 , 2}}{2}$$

3. Analytical calculation of the endpoints F₁, F₂ and E₁, E₂ (25, 26, 45, 46) of the parabola branches.
4. Rotation of parabola branch P₁ through the aperture angle −θ₁ in the medium and the parabola branch P₂ through the aperture angle θ₂ in the medium, and translation of the parabola branch P₂ along the x axis.
5. In the case of an asymmetric variant with θ₁≠θ₂ (31 and 32), the slope of the inclination surface determined by the points E₁ and E₂ is now determined.
6. The effective acceptance angles in air are determined from the design.
7. Comparison with the desired acceptance angles. If there is an insufficient match, beginning again at Point 1 with adapted acceptance angles.
8. If there is sufficiently accuracy, shortening—simple truncation—of the parabolas in the y direction to the extent determined by the shortening factor (36) with the new endpoints E₃ and E₄ (27 and 28)
9. Replacing the edge delimited by the points F₁ and F₂ (25, 26) by the n^{th} order polynomial, which is continuously differentiably closed.

In the present case, the CPCs are used in a different way from their original function. If a CPC is adapted so that its acceptance angles θ₁ and θ₂ (FIG. 3) lie just below the angle of incidence of the light on the diffuser plate in the region between two lamps, a luminous density increase is obtained at this freely definable position. The CPC defined in this way determines the region between the points 25 and 27 and between the points 26 and 28 in FIG. 1. The CPCs may be configured either symmetrically with the same aperture angles θ₁=θ₂ or asymmetrically with different aperture angles θ₁≠θ₂.

The polynomial region between the points 25 and 26 in FIG. 1 is a continuously adapted function. It may be an n^{th} order polynomial, a circle sector, an ellipse, a sinusoidal function, a parabola, a lens or a straight line. It is preferably an n^{th} order polynomial. It is particularly preferably a fourth order polynomial, which is continuously differentiable at the points 25 and 26.

The polynomial between the points 25 and 26, in combination with the lens region (lens) between the points 29 and 27, determines the height and width of a maximum in the region directly over the lamps. In the case of a plane surface, the luminous density is very high in a small spatial range but falls off steeply. The diverging effect of the lens in this region leads to widening and simultaneous lowering of this maximum. This widening can be controlled by means of the curvature of the region. Here, the determining parameter is the normalised focus of the diverging lens. The lens may be calculated according to the following formula: sinusoidal, n^{th} order polynomial, parabola hyperbola, ellipse, circle, circle arc segment, straight line. It is preferably an ellipse.

The last design parameter is the ratio of the two subregions 24 and the sum of 21, 22 and 23 together. By means of this ratio, the maximum between the lamps and directly above the lamps can be brought to an identical luminous density level. Depending on which function is used in the polynomial region, a corresponding function must be used in the lens region. Preferred combinations are summarised in the following table:

| Lens | Polynomial |
|---|---|
| n^{th} order polynomial | n^{th} order polynomial |
| n^{th} order polynomial | Sinusoidal |
| compressed circle | n^{th} order polynomial |

By tripling the maxima, in comparison with doubling in the case of the conventional lenticular structure, the homogenisation effect in the same system is much greater. The position of the maxima, as well as their width and maximum intensity, can also be adapted separately from one another. The structure is therefore also suitable for demanding LED lighting units (for example few lamps, thinner constructs).

The structure can be exactly described mathematically by a few parameters, and adapted to the respective design of the LED lighting unit. Very homogeneous illumination is therefore possible. Furthermore, in contrast to conventional systems based on bulk scattering, the effect is independent of the thickness of the scattering sheet, which offers an additional degree of freedom in the design.

In another embodiment, the scattering sheet has a surface structure with a scattering effect on the rear side.

In another embodiment, the scattering sheet has a UV-absorbing layer on the rear side.

In another embodiment, the scattering sheet has overmodulated structures, which achieve an additional scattering effect, in the translation-invariant direction.

The scattering sheet or the scattering sheets used preferably contain at least one transparent thermoplastic.

The thermoplastic may preferably be at least one thermoplastic selected from polymers of ethylenically unsaturated monomers and/or polycondensates of bifunctional reactive compounds and/or polyaddition products of bifunctional reactive compounds, preferably at least one thermoplastic selected from polymers of ethylenically unsaturated monomers and/or polycondensates of bifunctional reactive compounds.

Particularly suitable thermoplastics are polycarbonates or copolycarbonates based on diphenols, poly- or copolyacrylates and poly- or copolymethacrylates such as for example and preferably polymethyl methacrylate or poly(meth)acrylate (PMMA), poly- or copolymers with styrene such as for example and preferably polystyrene or polystyrene acrylonitrile (SAN), thermoplastic polyurethanes, and polyolefins, such as for example and preferably polypropylene types or polyolefins based on cyclic olefins (for example TOPAS®, Hoechst), poly- or copolycondensates of terephthalic acid, such as for example and preferably poly- or copolyethylene terephthalate (PET or CoPET), glycol-modified PET (PETG), glycol-modified poly- or copolycyclohexane dimethylene terephthalate (PCTG) or poly- or copolybutylene terephthalate (PBT or CoPBT) or mixtures of those mentioned above. Polyolefins, such as for example polypropylene, without addition of other thermoplastics mentioned above are however less preferred for the method.

Preferred thermoplastics are polycarbonates or copolycarbonates, poly- or copolyacrylates, poly- or copolymethacrylates, polystyrene, poly- or copolycondensates of terephthalic acid or blends containing at least one of these thermoplastics. Polycarbonates or copolycarbonates are particularly preferred, in particular with average molecular weights M_{W} of from 500 to 100,000, preferably from 10,000 to 80,000, particularly preferably from 15,000 to 40,000 or blends containing these.

The scattering sheet preferably has a transmission of more than 90%, in particular more than 95%.

The scattering sheet used may be produced by extrusion.

In particular cases, an additional surface structure having a scattering effect on the front side and/or the rear side further increases the effect of the improved homogenisation of the light distribution.

The scattering sheets with the light-guiding ACPC structures, as used, may be produced by extrusion, injection moulding, injection compression moulding, hot stamping, cold stamping or high-pressure deformation, preferably by extrusion. For extrusion, the structure is provided in one of the rollers. The structure may be applied onto the roller by ultra-precision milling, laser processing, chemical structuring, photolithography or other technologies known to the person skilled in the art.

The scattering sheets may furthermore have a plurality of layers, a central layer and optionally further layers on the front side and/or on the rear side.

The scattering sheet preferably has a thickness of from 50 to 1000 μm, particularly preferably from 50 to 700 μm, more particularly preferably from 100 to 600 μm, and in particular from 250 to 500 μm. Here, the thickness of the scattering sheet is intended to mean the distance between the rear side and the maximum extent of the structure on the front side of the scattering sheet.

In a preferred embodiment, the lighting unit has at least one diffuser sheet, which contains scattering particles and is arranged in front of the scattering sheet, i.e. before its front side having the light-guiding structures consisting of a lens region and a complex CPC region. Such a diffuser sheet is preferably one based on a plastic as the base material, preferably a transparent plastic, which has scattering particles embedded in this base material.

The scattering particles may be polymer or inorganic particles. A wide variety of different substances may be envisaged as scattering particles, for example inorganic or organic materials. These may furthermore be present in solid, liquid or even gaseous form.

Examples of inorganic substances are for example salt-like compounds such as titanium dioxide, zinc oxide, zinc sulfide, barium sulfate etc., but also amorphous materials such as inorganic glasses.

Examples of organic substances are polyarylates, polymethacrylates, polytetrafluoroethylene, polytrialkyloxysiloxanes. The scattering particles may be polymer particles based on acrylate with a core-shell morphology. In this case, for example and preferably, they are those as disclosed in EP-A 634 445.

Examples of gaseous materials may be inert gases such as nitrogen, noble gases, but also air or carbon dioxide. They are “dissolved” under pressure in the polymer melt and processed to form the scattering sheet, for example by extrusion methods. Gas bubbles are then formed when cooling/relaxing the sheet.

These scattering particles may furthermore have a very wide variety of the geometries, from spherical shape to geometrical shape, as presented by crystals. Transition shapes are likewise possible. It is furthermore possible for these scattering particles to have different refractive indices over their cross section, for example as a result of coatings of the scattering particles or as a result of core-shell morphologies.

The scattering particles are useful for imparting light-scattering properties to the transparent plastic in which they are embedded. The refractive index n of the scattering particles preferably lies within +/−0.25 units, more preferably within +/−0.18 units of the refractive index, most preferably within +/−0.12 units of the transparent plastic. The refractive index n of the scattering particles preferably lies no closer than +/−0.003 units, more preferably no closer than +/−0.01 units, most preferably no closer than +/−0.05 units to the refractive index of the transparent plastic. The refractive index is measured according to the standard ASTM D 542-50 and/or DIN 53 400.

The scattering particles generally have an average particle diameter of at least 0.5 μm, preferably at least 2 μm, more preferably from 2 to 50 μm, most preferably from 2 to 15 μm. An “average particle diameter” is to be understood as the number average.

Preferably at least 90 wt. %, most preferably at least 95 wt. % of the scattering particles have a diameter of more than 2 μm. The scattering particles are preferably a freely flowing powder.

The scattering particles in the base material are preferably used in an amount of from 0.001 to 10 wt. %, preferably from 0.01 to 5 wt. %, expressed in terms of the total weight of the base material.

In another preferred embodiment, the lighting unit contains at least two, and preferably two, of the scattering sheets, each of which has light-guiding structures on the front side that consist of a lens region and a convex CPC region, the second scattering sheet being arranged with the rear side before the front side of the first scattering sheet and the light-guiding structures of the second scattering sheet being arranged rotated relative to the light-guiding structures of the first scattering sheet by an angle of between 30 and 150°, particularly preferably between 60 and 120°, more particularly preferably by 90°.

The embodiments of the lighting unit as mentioned above exhibit a significantly improved homogenisation of the light distribution.

The lighting unit preferably has a light box, i.e. a housing, which accommodates the light-reflecting surface, the LED(s), scattering sheets(s) and optionally diffuser sheets(s). It may be a box having flat front and rear sides, and arbitrarily shaped side surfaces; more complex constructs may have side surfaces which have different shapes on the inside and outside. The base plate of this light box preferably represents a or the light-reflecting surface. To this end, the light box is particularly preferably configured so as to be diffusely reflective or metallically reflective, more particularly preferably diffusely white-reflective. To this end, the base plate on its own or both the base plate and the side surfaces of the light box may be configured on the inside so as to be diffusely reflective or metallically reflective, more particularly preferably diffusely white-reflective.

The light-reflecting surface(s) may preferably be diffusely reflective or metallically reflective, and it/they are preferably diffusely white-reflective.

The LEDs are preferably placed internally on the rear side of the light box and may be arranged in a regular grid or irregularly. The LEDs made be point or line light sources. For the case of arrangement in a regular grid, this grid may be described by the number of rows in the longitudinal (n) and transverse (m) directions. The numbers of rows represented by the variables “n” and “m” are respectively numbers greater than or equal to 1.

The following examples serve for exemplary explanation of the invention and are in no way to be interpreted as limiting.

### EXAMPLE 1

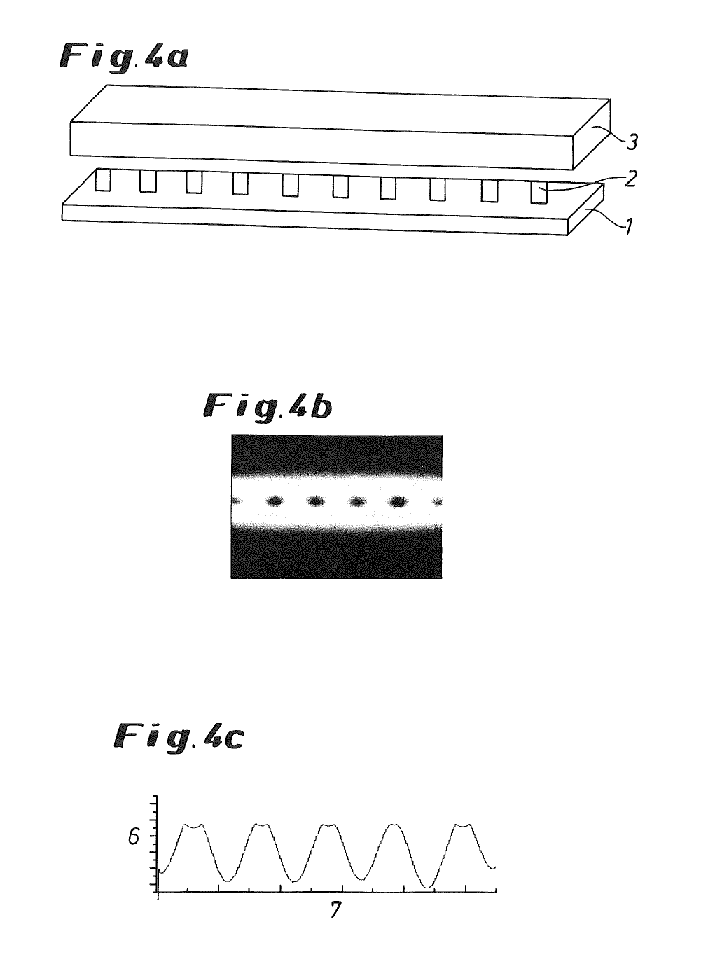

This example is a comparative example and does not represent an embodiment of the invention. A lighting unit having a reflector and 6 linearly arranged light emitting diodes (LEDs) with an LED midpoint spacing of 50 mm and a distance of the LEDs from the diffuser equal to 15 mm was prepared. A conventional diffuser plate was used for this: a standard acrylate diffuser plate from Sumitomo Chemical, Sumipex® FX 151. The construction of this lighting unit is shown in FIG. 4a. The brightness variation (standard deviation) over the lamps was 33%. The brightness variation is represented in FIG. 4c as a linear section through the midpoints of the LEDs. For the human eye, this gave the impression of clearly different point light sources. The brightness variation which was used as the basis for the measurement FIG. 4c was recorded by a CCD camera from STARLIGHT XPRESS Ltd., model SXVF-H9 and is represented in FIG. 4b.

### EXAMPLE 2

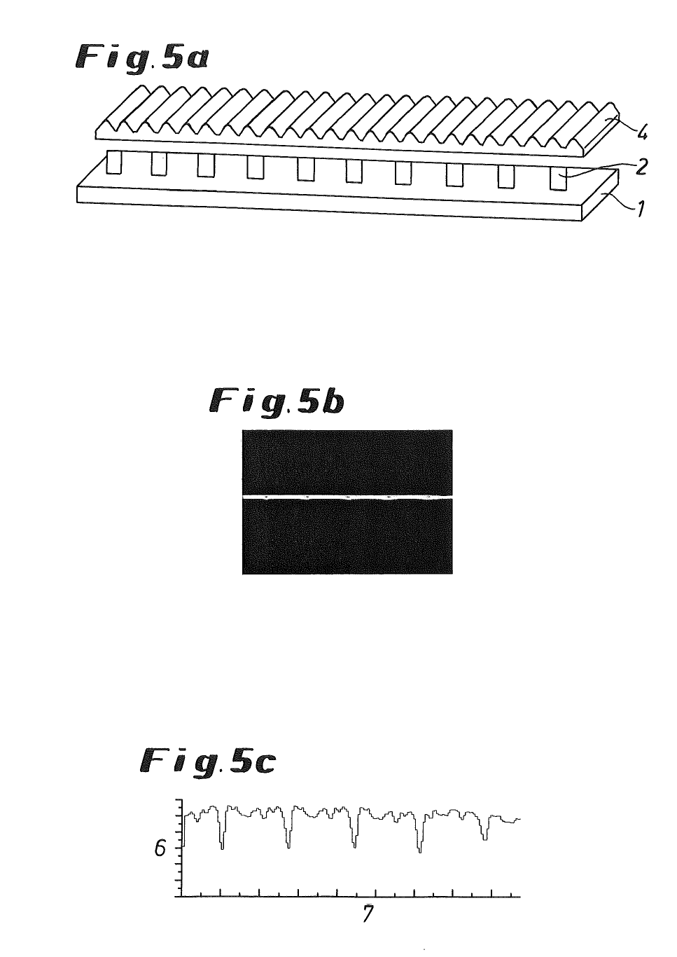

This example represents an embodiment of the invention. A lighting unit having a reflector and 6 linearly arranged light emitting diodes (LEDs) with an LED midpoint spacing of 50 mm and a distance of the LEDs from the diffuser equal to 15 mm was prepared. A 280 μm scattering plate having an ACPC structure with the following parameters was provided as the diffuser: acceptance angle 40°, shortening factor: 0.1, polymer: polycarbonate based on bisphenol A (Makrolon® 3108 (high-viscosity BPA-PC, MFR 6.5 g/10 min according to ISO 1133 at 300° C. and with 1.2 kg)), lens structure: a straight (flat), ratio: 0.03, polynomial region: 2^{nd} order polynomial. The linear structure of the ACPC scattering sheet was oriented transversely (vertically) to the LED arrangement. The construction of this lighting unit is shown in FIG. 5a. The brightness variation over the lamps was 12%. The brightness variation is represented in FIG. 5c as a linear section through the midpoints of the LEDs. For the human eye, this gave the impression of a linear light source. The brightness variation which was used as the basis for the measurement in FIG. 5c was recorded by a CCD camera from STARLIGHT XPRESS Ltd., model SXVF-H9 and is shown in FIG. 5b.

### EXAMPLE 3

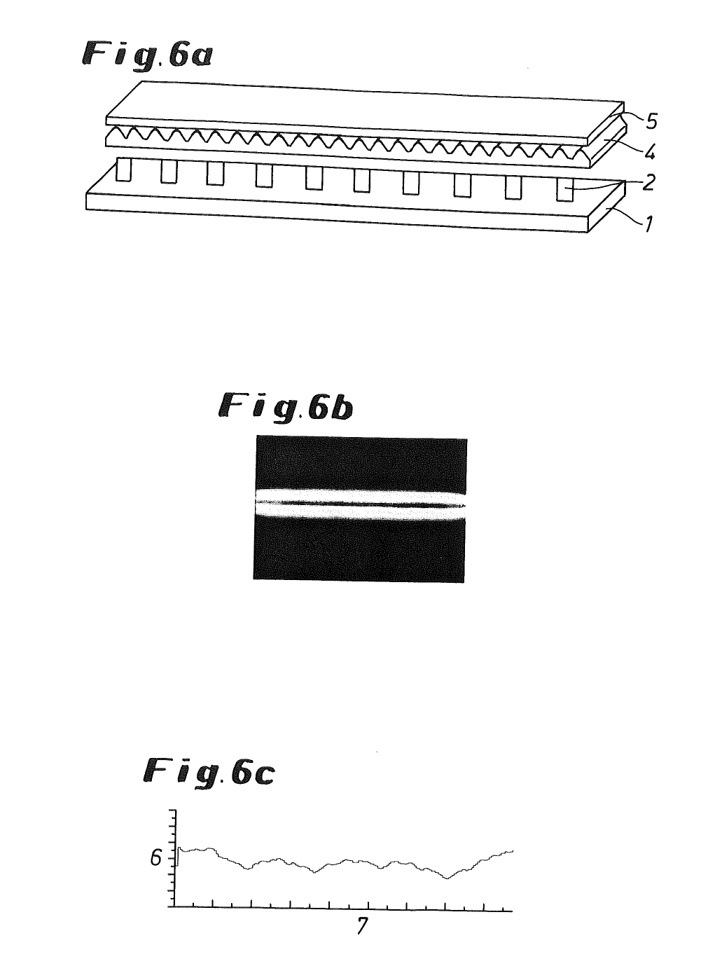

This example also represents an embodiment of the invention. A lighting unit having a reflector and 6 linearly arranged light emitting diodes (LEDs) with an LED midpoint spacing of 50 mm and a distance of the LEDs from the diffuser equal to 15 mm was prepared. A 280 μm scattering plate having an ACPC structure with the following parameters was provided as the diffuser: acceptance angle 40°, shortening factor: 0.1, polymer: polycarbonate based on bisphenol A (Makrolon® 3108 (high-viscosity BPA-PC, MFR 6.5 g/10 min according to ISO 1133 at 300° C. and with 1.2 kg)), lens structure: a straight (flat), ratio: 0.03, polynomial region: 2^{nd} order polynomial. The linear structure of the ACPC scattering sheet was oriented transversely (vertically) to the LED arrangement. On this, a further scattering sheet was placed (4 wt. % of commercially available core-shell acrylate scattering particles Paraloid® EXL 5137 from Rohm & Haas in Makrolon® 3108) with a thickness of 375 μm. The construction of this lighting unit is shown in FIG. 6a. The brightness variation over the lamps was 10%. The brightness variation is represented in FIG. 6c as a linear section through the midpoints of the LEDs. For the human eye, this gave the impression of a broadened linear light source. The brightness variation which was used as the basis for the measurement in FIG. 6c was recorded by a CCD camera from STARLIGHT XPRESS Ltd., model SXVF-H9 and is shown in FIG. 6c.

Thus, a lighting unit is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A lighting unit, comprising:
at least one light-reflecting surface;
one or more light-emitting diode(s) (LED(s)); and
at least one scattering sheet made of at least one transparent plastic,
the LED(s) being arranged in front of the at least one reflective surface and behind the at least one scattering sheet,
wherein at least the front side of the scattering sheet comprises light-guiding structures consisting of a lens region and a convex compound parabolic concentrator (CPC) region.

2. The lighting unit according to claim 1, wherein the CPC region can be determined by:
a) calculating the aperture angles θ₁ and θ₂ in the medium from the Fresnel equations by means of the defined acceptance angles;
b) constructing the parabola branch P₁ with the aperture angle θ₁ in the medium and the parabola branch P₂ with the aperture angle θ₂ in the medium according to the equation:
$${y}_{1 , 2} = \frac{{( x ∓ cos {θ}_{1 , 2} )}^{2}}{2 ( 1 ∓ sin {θ}_{1 , 2} )} - \frac{1 \pm sin {θ}_{1 , 2}}{2}$$
where θ_{1,2} is the aperture angle in the medium of the left (θ₁) and right (θ₂) parabola, x is the X coordinate, and y_{1,2} is the Y coordinate of the left (y₁) and right (y₂) parabola;
c) calculating the endpoints F₁, F₂ and E₁, E₂ of the parabola branches;
d) rotating the parabola branch P₁ through the aperture angle −θ₁ in the medium and the parabola branch P₂ through the aperture angle θ₂ in the medium, and translating the parabola branch P₂ along the x axis;
e) determining the effective acceptance angles in air from the geometry constructed in steps a) to e);
f) comparing the effective acceptance angles with the defined acceptance angles and, if there is a difference of more than 0.001%, repeating the previous steps with corrected acceptance angles instead of the defined acceptance angles in step a), the corrected acceptance angles not being equal to the defined acceptance angles, and the corrected acceptance angles being selected so that the effective acceptance angles from step f) coincide with the defined acceptance angles; and
g) when a difference of 0.001% or less is reached between the effective acceptance angles and the defined acceptance angles, shortening the parabolas in the y direction by the extent determined by the shortening factor.

3. The lighting unit according to claim 2, wherein the structure between the two points F1 and F2 of a CPC region can be described by a continuous polynomial function.

4. The lighting unit according to claim 2, wherein the CPC region can further be determined by determining the slope of the inclination surface determined by the points E₁ and E₂, in the case of an asymmetric variant with θ₁≠θ₂, prior to determining the effective acceptance angles in air from the geometry constructed.

5. The lighting unit according to claim 1, wherein the scattering sheet contains at least one thermoplastic polymer.

6. The lighting unit according to claim 1, further comprising at least one diffuser sheet in front of the scattering sheet, which contains scattering particles.

7. The lighting unit according to claim 1, wherein the reflective surface is a diffusely light-reflecting surface

8. The lighting unit according to claim 7, wherein the diffusely light-reflecting surface is a white diffusely light-reflecting surface.

9. The lighting unit according to claim 1, wherein one light-reflecting surface forms a base plate of a light box, which accommodates at least the LED(s) and the scattering sheet(s).

10. The lighting unit according to claim 9, wherein the light box further accommodates the diffuser sheet(s)

11. The lighting unit according to claim 1, wherein the scattering sheet(s) each have a thickness of from 50 to 1000 μm.

12. The lighting unit according to claim 1, wherein the light-guiding structures are translation-invariant.

13. The lighting unit according to claim 1, wherein the scattering sheet has overmodulated structures, which achieve an additional scattering effect, in a translation-invariant direction.

14. The lighting unit according to claim 1, including at least two scattering sheets, wherein at least two of the scattering sheets are contained, each of which has light-guiding structures on the front side including a lens region and a convex CPC region, the second scattering sheet being arranged with the rear side before the front side of the first scattering sheet, and the light-guiding structures of the second scattering sheet being arranged rotated relative to the light-guiding structures of the first scattering sheet by an angle of between 30 and 150°.
